(19) United States
(12) Patent Application Publication
(10) Pub. No.: US 2002/0189885 A1
(43) Pub. Date: Dec. 19, 2002

(54) Hydrostatic power system

(76) Inventors: Richard T. Ruebusch, New Albany, IN (US); Kevin L. Johnson, Salem, IN (US)

Correspondence Address: BAKER & DANIELS, 111 E. WAYNE STREET, SUITE 800, FORT WAYNE, IN, 46802

(21) Appl. No.: 10/071,133

(22) Filed: Feb. 7, 2002

Related U.S. Application Data
(60) Provisional application No. 60/298,971, filed on Jun. 18, 2001.

(51) Int. Cl. B60K 17/356

(52) U.S. Cl. 180/305

(57) ABSTRACT

A power system including an engine having a crankcase and a vertical output shaft, and a pump unit having a housing fixed to the engine crankcase and including at least one hydrostatic pump operatively coupled to the engine output shaft. The hydrostatic pump has fluid ports through which the pump unit is placed in fluid communication with at least one hydrostatic motor located outside the pump unit housing.

### CROSS-REFERENCE TO RELATED APPLICATION

This application claims the benefit under 35 U.S.C. §119(e) of United States Provisional Application No. 60/298,971, filed Jun. 18, 2001.

### BACKGROUND OF THE INVENTION

1. Field of Invention

The present invention relates to power systems for implements such as, for example, tractors, mowers, and snow throwers, comprising at least an internal combustion engine and a hydrostatic pump unit and which may be attached to a transmission having a hydrostatic motor.

2. Description of the Related Art

It is well-known to provide a power system which has an internal combustion engine mounted directly to the housing of a hydrostatic transaxle. Disposed within the transaxle housing are a hydrostatic pump, a hydrostatic motor, gear reduction means, and an axle. U.S. Pat. No. 5,067,933 (Hardesty et al.) discloses such a power system in which the output shaft of the engine is directly coupled to the hydrostatic pump, and the hydrostatic motor is coupled to the gear reduction means, which in turn drives a differential-equipped axle. It is also known, as further disclosed in Hardesty et al. '933, to utilize a portion of the engine and/or driving axle lubricating oil as the working oil or hydraulic fluid which circulates between the pump and motor.

Although power systems of this type eliminate the need for a belt to drive the hydrostatic pump with the engine, and provides a fairly compact unit, these power systems offer little flexibility in accommodating the drive train layouts of various tractors or riding mowers or in accommodating variously matching transmissions and engines. Further, such previous power systems to not provide selectively actuated power take-off (PTO) shafts, which are useful for controlling working devices such as mower decks and auger assemblies. Nor do previous power systems provide a means for individually selectively driving a pair of drive wheels at various speeds in forward and reverse directions, which may be used in zero turn radius mowers.

A power system comprising an internal combustion engine and at least the pumps of a hydrostatic transmission, which provides the flexibility lacking in previous power systems is desirable.

### SUMMARY OF THE INVENTION

In overcoming the above described shortcomings of prior art systems, a power system is provided including an engine having a crankcase and a vertical output shaft and a pump unit having a housing fixed to the engine crankcase and including at least one hydrostatic pump disposed in the housing. The pump is operatively coupled to the engine output shaft and has fluid ports through which the pump unit is placed in fluid communication with a hydrostatic motor located outside the pump unit housing. The engine crankcase may be separate from, or integral with, the pump unit housing. Further, the engine and pump unit may be directly fixed to the casing of a transaxle having at least one hydrostatic motor therein.

An advantage of the inventive power system is its modular configuration, which offers greater flexibility in accommodating various drive train layouts or accommodating various matching transmissions and engines.

The present invention utilizes a modular configuration for the formation of a power system. In one form thereof, the present invention has the pump unit and the engine being attached to each other to form a first level module to which a transaxle unit can be attached to form a second level module. In another form thereof, the engine, pump unit, and transaxle unit can be attached to one another to form a first level module. The terminology of “first level module” and “second level module” serves to signify the number of levels of assembly for the particular unit of interest. Thus, when the engine and the pump unit are assembled, with the transaxle being added at a later time or different location, the engine and pump unit form a single level module as there was only one level of assembly. The addition of the transaxle unit to the first level module requires an additional level of assembly, thus the first level module with the transaxle unit becomes a second level module.

The present invention further provides a lawn and garden implement including a frame, a handle mounted to the frame, a power system disposed within the frame, at least one hydrostatic motor, and a wheel operatively connected to the hydrostatic motor. The power system includes an engine having a crankcase and a vertical output shaft, and a pump unit having a housing fixed to the engine crankcase and including at least one hydrostatic pump operatively coupled to the engine output shaft. The at least one hydrostatic motor is located outside the pump unit housing and has fluid ports through which the pump unit is placed in fluid communication with the hydrostatic motor.

The present invention also provides a method of manufacturing a power system for an implement, including selecting one of a plurality of engines with each engine having a crankcase and a vertical output shaft, selecting a pump unit from a plurality of pump units with each said pump unit having a housing, connecting the pump unit and the engine at a first facility through the operative engagement of the vertical output shaft and the pump unit, and attaching the pump unit housing to the engine crankcase at the same facility, thereby forming a first level module.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1A is a schematic view of an implement including a power system module having an engine and a pump drive unit in accordance with the present invention;

FIG. 1B is a schematic view of a first embodiment of the inventive module combined with a transaxle;

FIG. 2A is a schematic view of a second embodiment of the inventive module in which the pump drive unit and the engine share a common housing;

FIG. 2B is a schematic view of the second embodiment of the inventive module having been attached to a transaxle as a second level module;

FIG. 3 is schematic view of a third embodiment of the inventive module, the pump drive unit having two independent pumps therein;

FIG. 4 is a schematic view of a fourth embodiment of the inventive module, the pump drive unit including an auxiliary pump;

FIG. 5 is a schematic view of a fifth embodiment of the inventive module in which the engine, pump drive unit, and transaxle form one module;

FIG. 6 is a schematic view of a sixth embodiment of the inventive module in which a differential is used in conjunction with a single pump and single motor arrangement;

FIG. 7 is a schematic view of a seventh embodiment of the inventive module in which no transaxle is attached; and

FIG. 8 is schematic view of an assembly plan for multiple embodiments of the inventive module.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate particular embodiments of the invention such exemplifications are not to be construed as limiting the scope of the invention in any manner.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended.

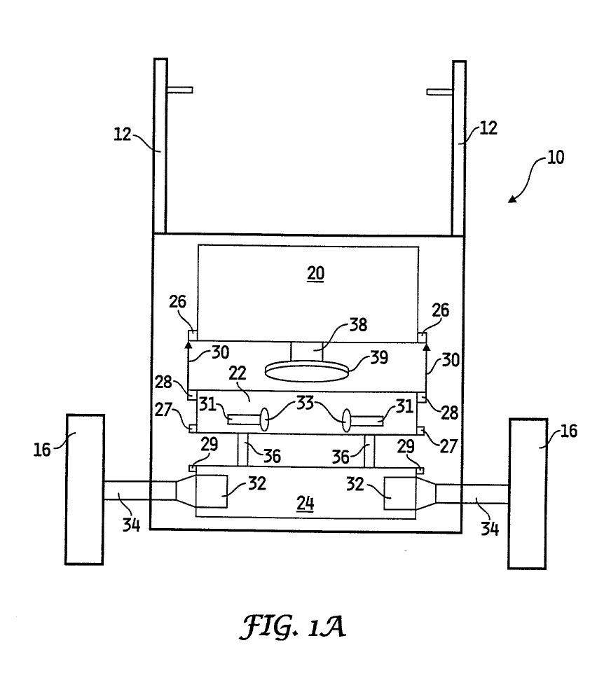

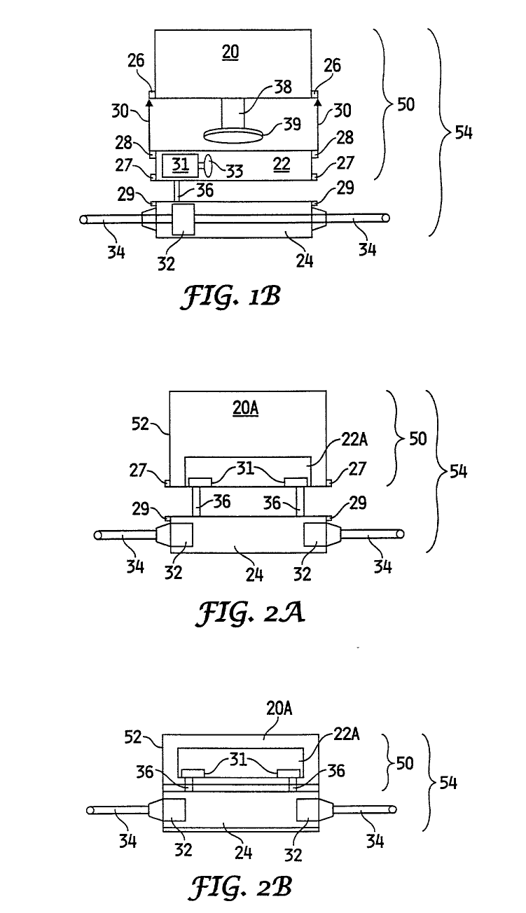

Referring first to FIG. 1A, a general schematic of the power system module, or the inventive engine and pump drive unit module, is shown within implement 10. Implement 10 is similar to that disclosed in U.S. patent application Ser. No. 09/785,431, filed Feb. 16, 2001, the disclosure of which is expressly incorporated herein by reference. The power system of implement 10 includes engine 20, pump drive unit 22, and transaxle 24 rotatably supporting axle 34. Implement 10 further includes handles 12, which may have a single handgrip or dual handgrips, as shown, and a ground engaging wheel 16 at each end of axle 34.

Engine 20 includes output shaft 38 and mounting bosses 26, which are used to connect the crankcase of engine 20 to pump drive unit 22 through cooperative engagement with bosses 28 of pump drive unit 22. As seen in FIG. 1B, pump drive unit 22 has a very low profile casing, or housing, and is assembled to the bottom of the crankcase of a vertical shaft engine 20, as depicted by arrows 30. In the first embodiment, shown in FIG. 1B, engine 20 has a crankcase and pump drive unit 22 has its own separate casing; alternatively, engine 20 may have a crankcase integrally formed with the housing of pump drive unit 22. Output shaft 38 of engine 20 drives each pump 31 of pump drive unit 22 through the operative engagement of gear 39 with gear 33 fixed to the input shaft of each variable displacement pump 31.

In all embodiments, the connection of pump drive unit 22 to engine 20 creates first level module 50, which may be shipped as a unit to the implement manufacturer for attachment to a transaxle or transmission during implement assembly. However, it is to be noted that addition of a transaxle or transmission is not required, rather the term “first level module” refers to there having been one level of assembly, i.e. that engine 20 and pump unit 22 have been assembled together; each module 50 has the minimum combination of an engine 20 and a pump drive unit 22. It is to be noted that a first level module 50 may also include more than engine 20 and pump drive unit 22, such as a transaxle 24 or other items, if the assembly of all the items occurs at a common facility, i.e., there is only one level of assembly, or there is only one place of assembly. If other items, such as a transaxle 24 are assembled to a first level module 50 at a different facility, rather than at the facility at which engine 20 and pump drive unit 22 are assembled, then a second level module 54 is created which may be shipped to the implement manufacturer as an individual stand alone unit. The term “second level module” refers to there having been two levels assembly or two places of assembly, i.e. the first assembly of engine 20 and pump unit 22 into first level module 50, and the second assembly of transaxle 24 and first level module 50 into second level module 54.

Transaxle 24, having bosses 29 engaged with bosses 27 of pump drive unit 22, is shown as including two hydrostatic motors 32 (FIGS. 1A, 2A-5), one driving each axle 34; however, it should be noted that transaxle 24 may include a single hydrostatic motor 32 and a single-piece axle 34 (FIG. 1B). In FIG. 1B, pump drive unit 22 includes a single pump 31 to provide a single pump/single motor arrangement, which may be used in implements such as snow throwers or wide area mowers.

An alternative single pump and single motor arrangement, similar to that of FIG. 1B, is shown in FIG. 6 and includes differential 56, of a type known in the art. Motor 32, through output shaft 58, provides the input to differential 56, which then drives each portion 34A and 34B of two-piece axle 34.

In either a single pump/single motor arrangement or a multiple pump/multiple motor arrangement, each hydrostatic motor 32 is in fluid communication with a hydrostatic pump 31 in pump drive unit 22 through fluid connections 36.

With reference to FIG. 2A, engine 20A, which is similar to engine 20, is shown with integral pump drive unit 22A, which is similar to pump drive unit 22, except that the pump unit housing is integral with the engine crankcase to create a first level module 50; the attachment of transaxle 24 to first level module 50 creates second level module 54, such as shown completely assembled in FIG. 2B. The crankcase of engine 20A and the housing of pump drive unit 22A are integral which enables engine 20A and pump drive unit 22A to be first level module 50 and attached to a separate transaxle 24 at a separate facility to create second level module 54. This embodiment of first level module 50, as shown in FIGS. 2A and 2B, has housing 52 comprising the crankcase of engine 20A integrally formed with the housing of pump drive unit 22. Again, each motor 32 located within transaxle 24 is in fluid communication with a separate pump 31 of the engine and pump drive unit module through fluid connections 36.

Referring now to FIG. 3, a third embodiment of the inventive power system is shown in which pump drive unit 22 is replaced by pump unit 22B. Pump drive unit 22B includes two separate pumps 40 and 42, the displacements of which may be varied independently of each other through independent swash plate movement and which are driven together by output shaft 38 of engine 20 through gears 39 and 33. Furthermore, each of pumps 40 and 42 may have independent fluid connections 36 to a respective motor 32 of transaxle 24 to directly, or through gears such as a reduction gear train, drive one of a pair of axles 34. Such an arrangement is particularly useful for implements such as zero turn radius mowers. Although the engine crankcase and pump unit housing are shown as being separate, but fixed together, it is to be noted that, alternatively, pump drive unit 22B may have a pump unit housing integrally formed with the crankcase of engine 20 to create first level module 50 similar to that depicted in FIG. 2.

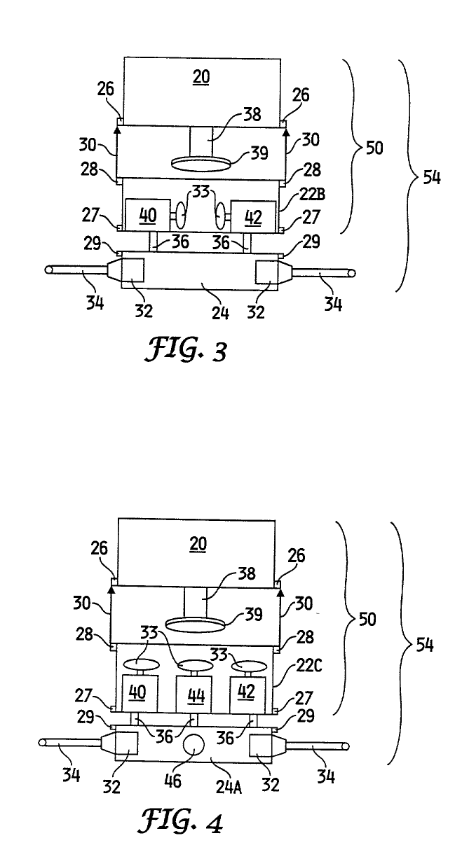

Referring to FIG. 4, a fourth embodiment of the inventive module is shown as having pump drive unit 22C. Pump drive unit 22C is similar to pump drive unit 22 with the exception that pump drive unit 22C includes three pumps: variable displacement pumps 40 and 42 which drive two motors 32, and third fixed displacement pump 44 which is used to drive a motor coupled to PTO shaft 46, as shown in FIG. 4. The fourth embodiment depicted in FIG. 4 also includes transaxle 24A replacing transaxle 24; transaxle 24A includes PTO shaft 46 driven by pump 44. The PTO system, including pump 44 and PTO shaft 46, may be engaged and disengaged through a valve means. Although the engine crankcase and pump unit housing are shown as being separate, but fixed together, it is again to be noted that pump drive unit 22C may have a pump unit housing integrally formed with the crankcase of engine 20 similar to that shown in FIG. 2.

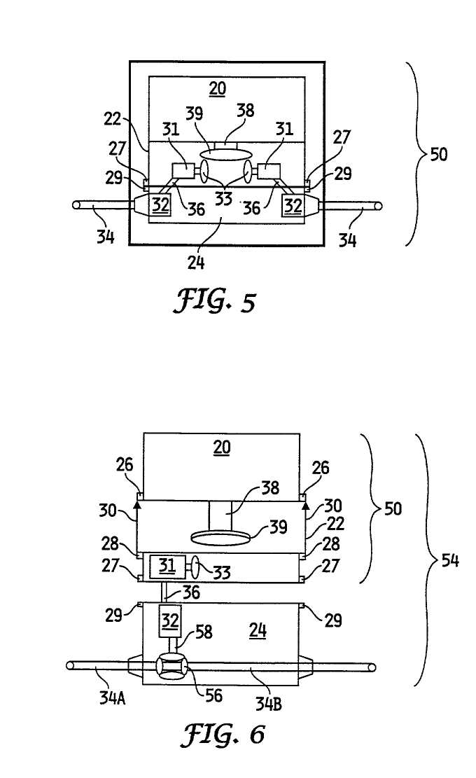

A fifth embodiment of the inventive engine and hydrostatic transmission module is shown in FIG. 5. This embodiment has engine 20, pump drive unit 22 and transaxle 24, all of which are assembled into a single first level module 50. This embodiment is considered to be a first level module 50 since the assembly of engine 20, pump drive unit 22, and transaxle 24 occurs at a single facility. As in previously described embodiments, output shaft 38 drives hydrostatic pumps 31 through gears 39 and 33. Pumps 31 are in fluid communication with hydrostatic motors 32 through fluid connections 36, as in previous embodiments and as is known in the art.

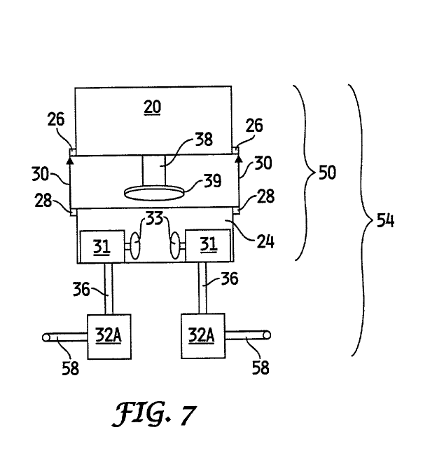

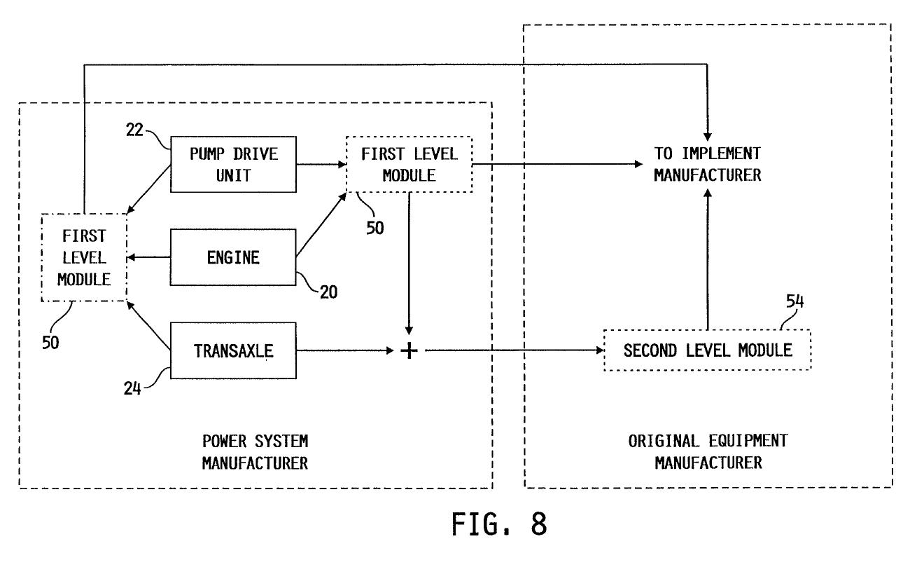

Although engine 20 and pump unit 22, after assembly as first level module 50, have been shown as being connected to a transmission or transaxle 24, first level module 50 may instead have its pumps 31 connected to individual stand-alone motors 32A, such as shown in FIG. 7. Motors 32A may be individually attached to the frame of an implement. Furthermore, it is to be noted that a first level module 50 may be connected to a transmission having an output shaft rather than to a transaxle having an axle.

In FIG. 8, the assembly plan for the various embodiments of the inventive power system is shown. As can be seen, pump drive unit 22 may be assembled to engine 20 at one facility, to create first level module 50, which, as described above, may be attached to transaxle 24 at a different facility, which may be an implement manufacturer, to create a second level module 54. The assembly of first level module 50 is always accomplished by the power system module manufacturer. Alternatively, first level module 50 may include a transaxle or a transmission attached to the engine and pump unit by the power system manufacturer at a separate facility, to form second level module 54 and then shipped to the implement manufacturer for final assembly in an implement.

As an additional alternative, pump drive unit 22, engine 20, and transaxle 24 may be assembled into a single first level module 50 at one facility, and then shipped to the implement, or original equipment, manufacturer. Such a module is shown in FIG. 5 and the assembly as a first level module 50 is described above.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A power system comprising:
an engine having a crankcase and a vertical output shaft; and
a pump unit having a housing fixed to said engine crankcase and including at least one hydrostatic pump operatively coupled to said engine output shaft, said hydrostatic pump having fluid ports through which said pump unit is placed in fluid communication with at least one hydrostatic motor located outside said pump unit housing.

2. The power system of claim 1, wherein said engine crankcase and said pump unit housing are integral.

3. The power system of claim 1, wherein said pump unit housing is detachably fixed to said engine crankcase forming a first level module, and said first level module comprises a plurality of said pump units, each said pump unit having a different number of said hydrostatic pumps.

4. The power system of claim 3, further comprising a transmission unit directly fixed to said first level module and comprising a hydrostatic motor in fluid communication with each said pump unit, and wherein said first level module and said transmission unit form a second level module.

5. The power system of claim 4, wherein said transmission unit is a transaxle unit having an axle supported therein and coupled to at least one said motor.

6. The power system of claim 5, wherein said axle is a single solid axle.

7. The power system of claim 5, wherein said axle is a split axle having two portions, each said portion of said axle coupled to a different said hydrostatic motor.

8. The power system of claim 1, further comprising a transaxle unit having a casing detachably fixed to said pump unit housing, at least one hydrostatic motor disposed in said casing and an axle coupled to said motor, said hydrostatic motor having fluid ports through which said motor is in fluid communication with said hydrostatic pump, and wherein said first level module and said transaxle unit form a second level module.

9. The power system of claim 8, wherein said axle is a single solid axle.

10. The power system of claim 8, wherein said axle is a split axle having two portions, each said portion of said axle coupled to a different said hydrostatic motor.

11. The power system of claim 8, wherein said axle is a split axle having two portions, said portions being driven by a differential, said differential operatively coupled to said motor.

12. The power system of claim 8, wherein said pump unit is one of a plurality of said pump units, each said pump unit having a different number of said hydrostatic pumps, and said transaxle unit is one of plurality of transaxle units, each said transaxle unit having a different number of said hydrostatic motors, each said motor being in fluid communication with a said pump.

13. A lawn and garden implement comprising:
a frame;
a handle mounted to said frame;
a power system mounted within said frame including:
an engine having a crankcase and a vertical output shaft; and
a pump unit having a housing fixed to said engine crankcase and including at least one hydrostatic pump operatively coupled to said engine output shaft;
at least one hydrostatic motor located outside said pump unit housing, said hydrostatic pump having fluid ports through which said pump unit is placed in fluid communication with said hydrostatic motor; and
a wheel operatively connected to said hydrostatic motor.

14. The implement of claim 13, further comprising a transaxle unit having a casing detachably fixed to said pump unit housing, said at least one hydrostatic motor disposed in said casing, and an axle coupled to said motor, wherein a said wheel is attached to each end of said axle.

15. The implement of claim 14, wherein said axle is a single solid axle.

16. The implement of claim 14, wherein said axle is a split axle having two portions, each said portion of said axle coupled to a different said hydrostatic motor.

17. The implement of claim 14, wherein said power system is a first level module, said first module and said transaxle unit forming a second level module.

18. A method of manufacturing a power system for an implement, comprising:
selecting one of a plurality of engines, each engine having a crankcase and a vertical output shaft;
selecting a pump unit from a plurality of pump units, each said pump unit having a housing;
connecting the pump unit and the engine at a first facility through the operative engagement of the vertical output shaft and the pump unit; and
attaching the pump unit housing to the engine crankcase at the same facility, thereby forming a first level module.

19. The method of claim 18 further comprising:
selecting a transaxle unit having at least one motor and a housing;
connecting the motor to the pump unit simultaneously with connecting the pump unit to the engine; and
attaching the transaxle unit housing to the pump unit housing simultaneously with attaching the pump unit housing to the engine crankcase at the same facility.

20. The method of claim 18 further comprising:
selecting a transaxle unit having at least one motor and a housing;
connecting the motor to the pump unit after the pump unit has been connected to the engine to form the first level module; and
attaching the transaxle unit housing to the first level module forming a second level module.

21. The method of claim 18 further comprising:
shipping the first level module to a second facility;
selecting a transaxle unit having at least one motor and a housing;
connecting the motor to the pump unit after the formation of the first level module; and
attaching the transaxle unit housing to the first level module forming a second level module.
